(19) United States
(12) Patent Application Publication
(10) Pub. No.: US 2010/0122110 A1
(43) Pub. Date: May 13, 2010

(54) METHOD AND APPARATUS FOR MANAGING ADVERTISING-ENABLED APPLICATIONS

(75) Inventor: Zoltán Ördögh, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/616,447

(22) Filed: Nov. 11, 2009

Related U.S. Application Data
(60) Provisional application No. 61/113,514, filed on Nov. 11, 2008.

(51) Int. Cl. G06F 11/07; G06F 15/16; G06N 5/02; G06Q 30/00

(52) U.S. Cl. 714/2; 709/224; 706/46; 714/E11.023; 705/14.73

(57) ABSTRACT

A method comprises determining a condition of a resource for a user device, the device having an advertisement application thereon; and sending a notification indicative of the condition of the resource to the advertisement application.

### RELATED APPLICATIONS

This application claims priority to U.S. Provisional Application No. 61/113,514, filed Nov. 11, 2008, which is hereby incorporated by reference in its entirety.

### FIELD OF INVENTION

This invention relates to wireless communication. In particular, certain embodiments of the present invention relate to mobile advertising in such wireless communication.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Open Mobile Alliance (OMA) is in the process of standardizing mobile advertising. Specifically, the standardization is directed at enabling the delivery of advertisements to mobile users. The basic requirements of standardized mobile advertising include a globally interoperable platform to accommodate mobile and converged ecosystems. The proposed mobile advertising standards are commonly referred to as “MobAd.”

### SUMMARY OF THE INVENTION

In one aspect of the invention, a method determining a condition of a resource for a user device, the device having a software component thereon; and sending a notification indicative of the condition of the resource to the software component. In one embodiment, the method further comprises sending a notification indicative of the condition of the resource to a server on a network. The server may be an advertisement server. In one embodiment, sending a notification includes sending the notification to the software component if the condition of the resource is determined to be critical. In one embodiment, the notification includes the operating level of the resource. The operating level may indicate whether the resource condition is critical or normal, or it may indicate a percentage availability of the resource. In one embodiment, the software component is an advertisement application.

In another aspect of the invention, a method comprises receiving a notification from an engine, the notification being indicative of a condition of a resource for a user device; and implementing corrective action based on the condition of the resource. In one embodiment, the method further comprises sending a message to the engine indicating the corrective action implemented. In one embodiment, the notification indicates that the condition of the resource is critical. In one embodiment, the notification includes the operating level of the resource. The operating level may indicate whether the resource condition is critical or normal. In one embodiment, indication of an estimated time or percentage availability of the resource may be included in the notification. In one embodiment, the engine is an advertisement engine.

In another aspect, an apparatus comprises a processor and a memory unit communicatively connected to the processor. The memory unit includes computer code for determining a condition of a resource for a user device, the device having a software component thereon; and computer code for sending a notification indicative of the condition of the resource to the software component.

In another aspect, an apparatus comprises a processor and a memory unit communicatively connected to the processor. The memory unit includes computer code for receiving a notification from an engine, the notification being indicative of a condition of a resource for a user device; and computer code for implementing corrective action based on the condition of the resource.

In another aspect, the invention relates to a computer program product embodied on a computer-readable medium. The computer program product comprises computer code for determining a condition of a resource for a user device, the device having a software component thereon; and computer code for sending a notification indicative of the condition of the resource to the software component.

In another aspect, the invention relates to a computer program product embodied on a computer-readable medium. The computer program product comprises computer code for receiving a notification from an engine, the notification being indicative of a condition of a resource for a user device; and computer code for implementing corrective action based on the condition of the resource.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Example embodiments of the invention are described by referring to the attached drawings, in which:

FIG. 1 is a schematic illustration of an exemplary architecture of a mobile advertising arrangement according to an embodiment of the present invention;

FIG. 2 is a schematic illustration of an exemplary mobile device according to an embodiment of the present invention;

FIG. 3 is a schematic illustration of the exemplary mobile device of FIG. 2 with certain additional components according to an embodiment of the present invention;

FIG. 4 illustrates an exemplary information flow in accordance with embodiments of the present invention;

FIG. 5 is an overview diagram of a system within which various embodiments of the present invention may be implemented;

FIG. 6 illustrates a perspective view of an example electronic device which may be utilized in accordance with the various embodiments of the present invention; and

FIG. 7 is a schematic representation of the circuitry which may be included in the electronic device of FIG. 6.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

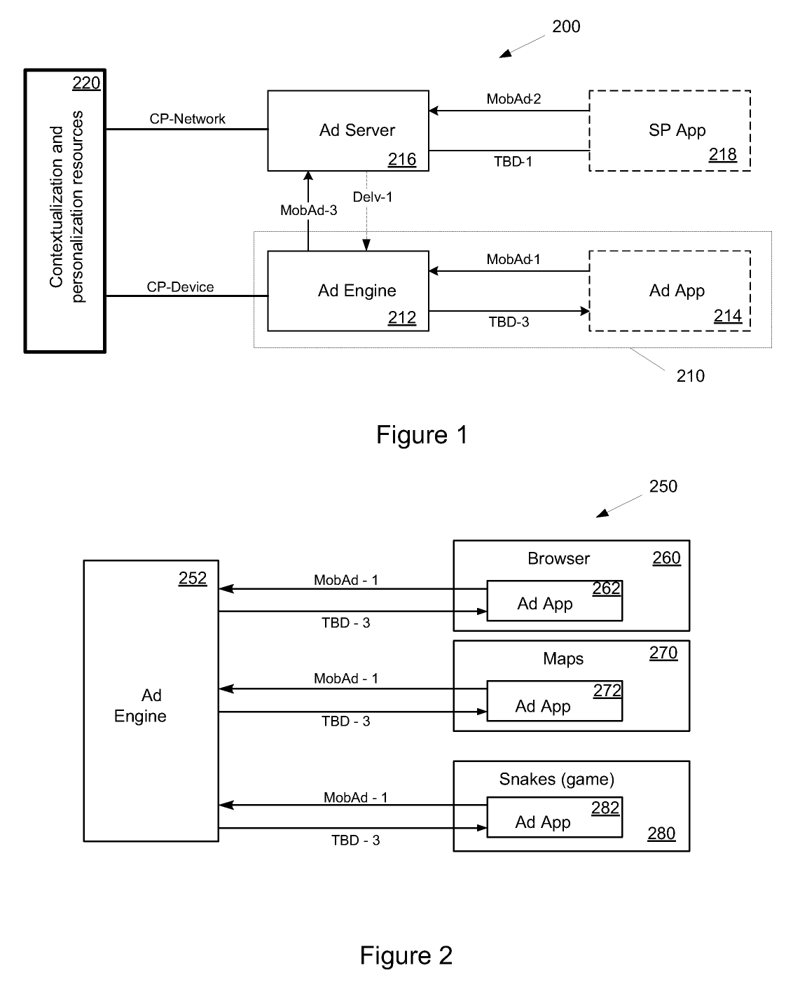

FIG. 1 is a schematic illustration of an exemplary architecture of a mobile advertising arrangement according to an embodiment of the present invention. In the illustrated embodiment, the arrangement 200 includes a user device 210 with an advertisement engine 212 and a software component, such as an advertisement application 214. In other embodiments, the software component may be any other software running on the user device 210. In various embodiments, the advertising application 214 may reside in the device 210 on its own or, alternatively, be embedded in specific applications of the device 210. In this regard, the advertisement application 214 may be coded into the specific application directly or through an adapter, such as a plug-in.

In the illustrated embodiment, the arrangement 200 also includes an advertisement server 216. The advertisement server 216 may include various data related to advertisements to be delivered to the user. The advertisement server 216 is communicatively coupled to a service-provider (SP) application 218. As SP application 218 may be an external entity to the network which interacts with MobAd enabler entities, such as the advertisement server 216. Further, various contextualization and personalization resources (C&PR) 220 may be provided to, for example, customize the advertisements to be delivered to the user. C&PR are information enablers and repositories relevant to the user, which are outside the MobAd enabler entities, such as the advertisement engine 212. The C&PR may be located in the service provider domain and may be accessible by the advertisement engine 212 and/or the advertisement server 216. In other embodiments, the C&PR may be located on the device 210. In various embodiments, the advertisement server 216, the SP application 218 and the various resources 220 may be network components.

In some embodiments, the user device may include two or more advertisement applications. For example, FIG. 2 illustrates a user device 250 with three applications: a browser 260, a maps application 270 and a game application 280. Each application 260, 270, 280 includes a corresponding, embedded advertisement application 262, 272, 282, respectively. Each advertisement application 262, 272, 282 may be an interpreter that interacts with an advertisement engine 252 of the device 250. The advertisement engine 252 ensures that the appropriate advertisements are presented at the appropriate places within each particular application.

In various embodiments, the advertisement applications 262, 272, 282 may be coded directly into the corresponding application itself. In other embodiments, the advertisement applications 262, 272, 282 may be modular. Further, the advertisement applications 262, 272, 282 may be plug-ins that can be updated.

In the current configuration, the advertisement applications in the device may be unaware of the status of the network or various components, or resources, such as the battery, memory, or other resources of the device. For example, the advertisement applications may be unaware that:

whether the network is available or in a weak condition;

whether the battery level is low or adequate;

whether the device is in a sleep mode (e.g., the screen saver is active);

whether the amount of free memory is low or normal; or

whether the amount of storage space is low or normal.

For purposes of the present disclosure, a status of such components or resources may be a “critical condition” or a “normal condition.” In one embodiment, “critical condition” may refer to a negative status of such components or resources, such as, for example, low battery level, low storage space, device in sleep mode, etc. In one embodiment, the “normal condition” may refer to the current status of a normal operation or availability of the resource.

In accordance with embodiments of the present invention, a notification of the critical condition is provided to the advertisement application. In certain embodiments, the notification is sent both to the advertisement application and to the advertisement server.

When a program wishes to monitor various resources, it may do several things, among which may be:

determine the upper/lower limits specific to the current device;

determine the upper/lower safe thresholds specific to the current device;

monitor current values; and

compare the current values with the thresholds and limits.

In cases where the availability of resources may be limited, such as in a mobile device with limited memory, power, and processing capability, it is not desirable to have each application continuously query, monitor and compare all relevant resource metrics with thresholds and limits. Similarly, it is not desirable for a vendor to implement an application differently in every device with, for example, different thresholds or different query methods.

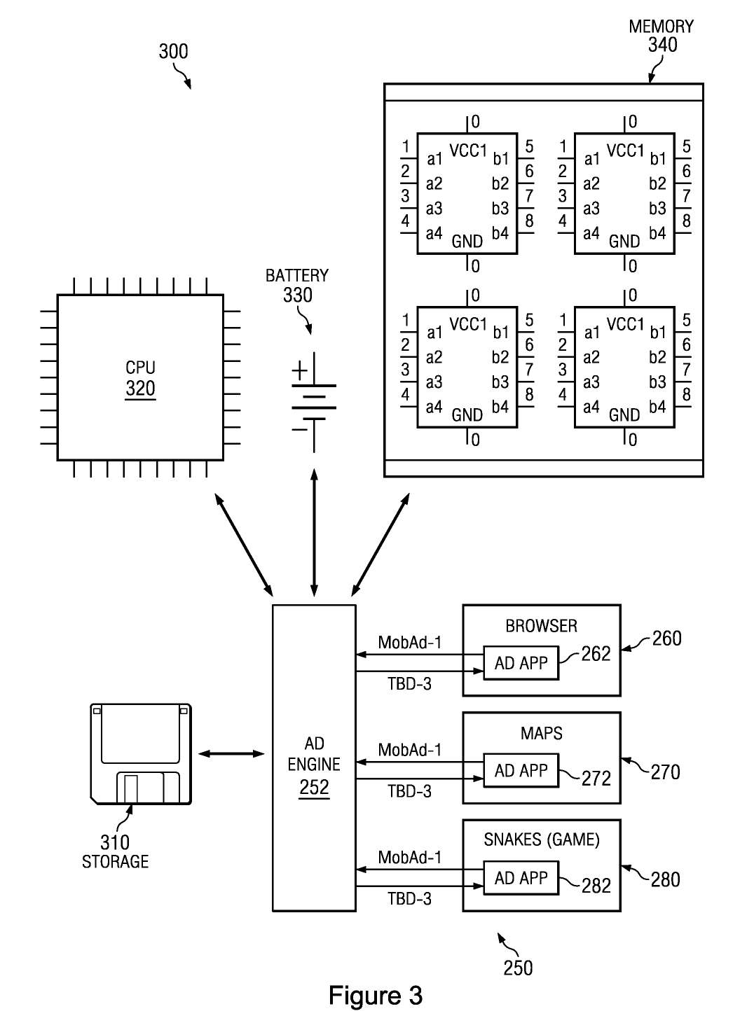

Referring now to FIG. 3, in accordance with embodiments of the present invention, the advertisement engine 252 in the device 250 is configured to monitor relevant metrics and compare them against the appropriate thresholds of the device 250. In this regard, the advertisement engine 252 may monitor the conditions of various resources such as, for example, a storage device 310, a processor 320, a power supply 330, and a memory 340. When the advertisement engine 252 determines that a condition of a certain resource is critical, it notifies the advertisement application 262, 272, 282 of the various applications 260, 270, 280 of the device 250. The notification from the advertisement engine 252 indicates that the resource is now in critical condition. In certain embodiments, when the advertisement engine 252 later determines that the conditions of a certain resource have returned to normal, the advertisement engine 252 notifies the advertisement application 262, 272, 282 of the various applications 260, 270, 280 of the device 250 that the resource is now in normal condition. Thus, upon receiving the notification, each advertisement application 262, 272, 282 is able to take appropriate action to alleviate the resource issue.

In some embodiments, it is sufficient for an application to know that the application is operating safely between resource thresholds/limits, without the need to be aware what these limits are. For certain cases, it may be unnecessary to monitor device resources for an advertisement application. For example, an advertisement application may not require knowledge of the remaining battery power, network bandwidth/latency, the amount of free memory or disk space. The only information the advertisement application may require is whether the advertisement engine determines the condition to be “normal” or “critical”.

In accordance with embodiments of the present invention, each advertisement application has an interface so the advertisement engine can contact the advertisement application with the notifications. The notifications may be in a variety of formats. Those skilled in the art will understand that the format of the notifications is not limited to any particular format.

In one embodiment, trusted advertisement applications may be registered and co-signed by the appropriate service provider. When an advertisement application starts up, it logs into the advertisement engine. The advertisement application will declare its identity and its intent to use advertisements. A login request may be used to declare a reference to the interface of the advertisement application, such as the MobAd-3 interface illustrated in FIG. 3. The advertisement engine may use the declared interfaces to push notifications to each registered advertisement application.

If the advertisement application is made aware of issues relating to the condition of various resources, the advertisement application may be configured to take actions to alleviate or accommodate such issues. For example:

it could stop attempting to access or use the network;

it may reduce battery usage by lowering performance needs (e.g., drop frame rate, drop level of detail, disable alpha-blending, turn off sound, or other things that the user can live without);

suspend advertisement rendering and metrics collection while the device is in sleep mode;

release unnecessary caches/buffers and reduce their usage by, for example, sending cached metrics; or

delete temporary files, use compression for its own data, or send unsent metrics to save disk space. For example, metrics, such as information regarding the user, may be collected and periodically sent. In order to alleviate critical issues, the unsent metrics may be deleted, either with or without sending.

The scope of the notifications in accordance with embodiments of the present invention is not limited to critical events related to device's resources. Notifications can also be used for communicating other conditions, such as, without limitation, the following exemplary cases:

User opt-in/opt-out from advertising. For example, if a long-running application which has fetched many advertisements but has not yet shown all of them to the user, the advertisement engine may notify the advertisement application to stop showing ads after the user has opted-out.

Ongoing calls. Using emergency identifiers may allow the advertisement application to be stopped from showing ads while the user is calling emergency services (e.g., ambulance, police, etc.) or when the user is taking any phone call.

Non-visible user interface. The advertisement engine may detect that an application is running in the background or hidden/covered by another application's window. In such a case, the advertisement engine may instruct the advertisement application not to waste system resources on advertisements while they are hidden.

Others. Other information may be important for the advertisement. For example, the advertisement application may be notified about changes in the user's location and/or presence information.

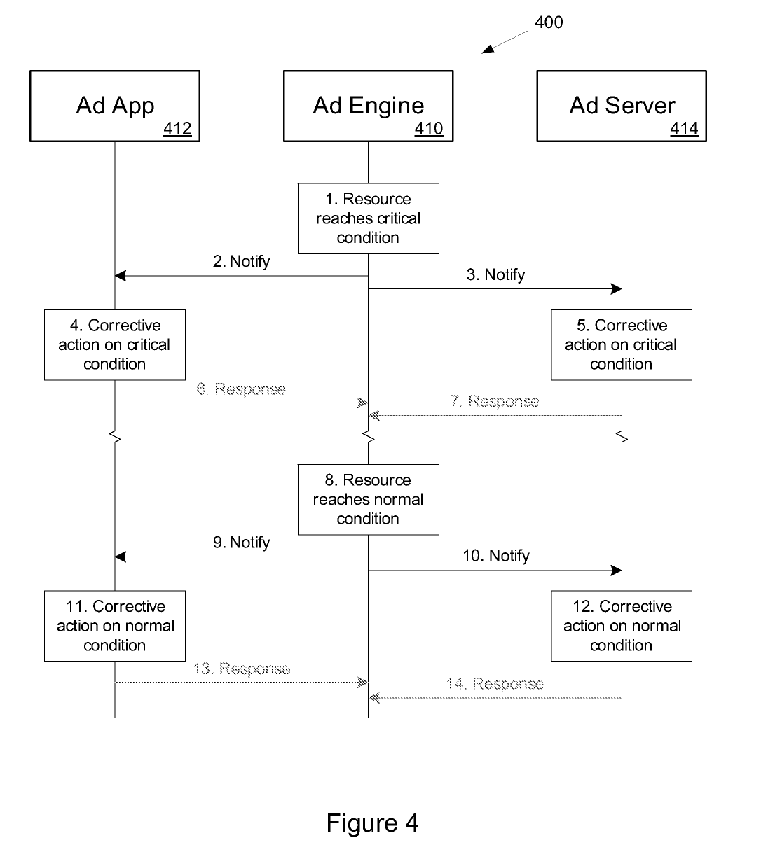

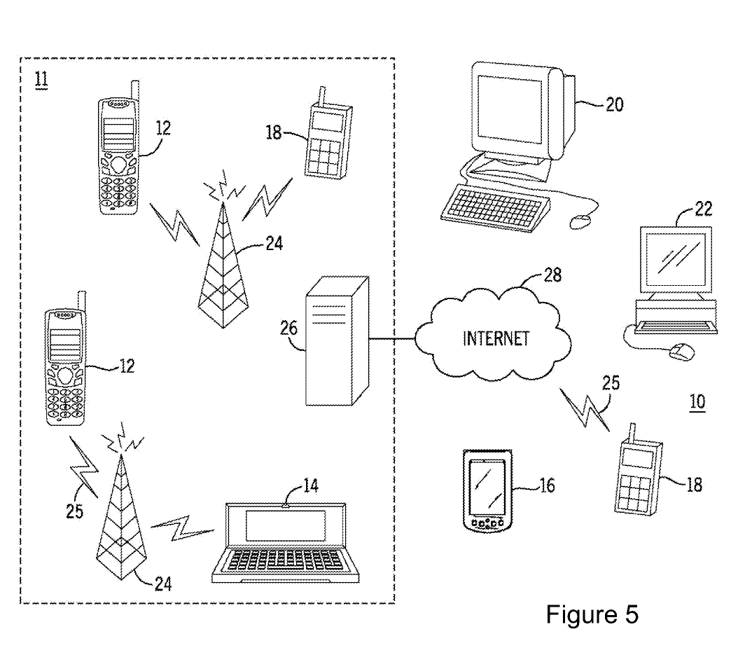

With reference to FIG. 4, an example embodiment of an optional call flow is illustrated. The notification from the advertisement engine to the advertisement server is applicable only when a push advertisement delivery is used (i.e., when the advertisement engine has no control over what is sent from the advertisement server).

The call flow 400 of FIG. 4 may be triggered by any of a number of events at the device when, for example, certain device resources reach critical or normal status. The device resources may include available memory, battery level, etc.

In accordance with the illustrated call flow 400, the advertisement engine 410 may receive a notification from, for example, the device that a device resource has reached critical condition (step 1). The advertisement engine 410 notifies the advertisement application 412 about the fact that the resource has reached critical status (step 2). The advertisement engine 410 notifies the advertisement server 414 about the fact that the resource has reached critical status (step 3).

The advertisement application 412 then decides to take a corrective action that alleviates the critical condition of the device resource until the status of the resource on the device has been restored to normal (step 4). Similarly, the advertisement server 414 decides to take corrective action that alleviates the critical condition of the device resource until the status of the resource on the device has been restored to normal (step 5).

In certain embodiments, the advertisement application 412 responds to the advertisement engine 410, conveying a confirmation and, in some embodiments, information about the corrective action (step 6). Similarly, the advertisement server 414 responds to the advertisement engine 410, conveying a confirmation and, in some embodiments, information about the corrective action it has taken (step 7).

When the advertisement engine 410 receives a notification, for example, from the device that the status of the resource on the device has been restored to an extent considered normal (step 8), the advertisement engine 410 notifies the advertisement application 412 about the fact that the resource is no longer under critical condition (step 9) and notifies the advertisement server 414 about the same fact (step 10). The advertisement application 412 may then take corrective action to restore normal operation (step 11). Similarly, the advertisement server 414 may take corrective action to restore normal operation (step 12).

In certain embodiments, the advertisement application 412 responds to the advertisement engine 410, conveying a confirmation and, in some embodiments, information about the corrective action (step 13). Similarly, the advertisement server 414 responds to the advertisement engine 410, conveying a confirmation and, in some embodiments, information about the corrective action it has taken (step 14).

As an example, when the device is low on power, the advertisement engine 410 notifies both the advertisement server 414 and the advertisement application 412 about the battery reaching critical status. The corrective action of the advertisement server 414 could be to suspend sending advertisement updates to the advertisement engine 410. The corrective action of the advertisement application 412 may be to reduce the frame rate at which the advertisements are rendered. This way, the advertisement server 414 and the advertisement application 412 help extend the lifetime of the critical resource, in this case, the battery. Once the battery level reaches acceptable levels, the advertisement engine 410 notifies both the advertisement server 414 and the advertisement application 412 about the resource reaching normal condition. The advertisement server 414 and the advertisement application 412 may both take corrective actions to restore their normal operation (unless, of course, there are other resources in critical status).

With reference to FIG. 1, the various interfaces will now be described. MobAd-1 is an interface between the advertisement engine 212 and the advertisement application 214. The advertisement engine 212 exposes this interface to the advertisement application 214. The advertisement application may use this interface to requests advertisements from the advertisement engine 212, as well as to report advertisement metrics data to the advertisement engine 212.

MobAd-2 is an interface exposed by the advertisement server 216 and used by the SP application 218 to submit an AdRequest message with some parameters, as well as to report metrics data. The parameters may be associated with a response to the AdRequest, which may be an advertisement. In general, the parameters should provide sufficient information for the advertisement server 216 to provide an appropriate response. The advertisement server 216 uses this interface to provide an AdResponse message to the SP application 218.

MobAd-3 is an interface exposed by the advertisement server 216 to:

submit an AdRequest message with some parameters and report metrics data. The advertisement server 216 use this interface to provide an AdResponse to the advertisement engine 212 and receive metric reports; and notify the advertisement server 216 about changes in status of the resources on a device.

Delv-1 is an interface exposed by the advertisement engine 212 for receiving advertisements and/or advertisement metadata from the advertisement server 216. In certain embodiments, the Delv-1 interface is used by the advertisement server 216 to communicate with the advertisement engine 212, while in other embodiments, another interface may be provided for such communication needs

TBD-1 represents a collection of all interfaces between the advertisement server 216 and the SP application 218, other than MobAd-2. TBD-3 is an interface exposed by the advertisement application 214 to receive notifications from the advertisement engine 212 about changes in status of the resources on a device. CP-Network represents a collection of all interfaces between C&PR and the advertisement server 216. CP-Device represents a collection of all interfaces between C&PR and the advertisement engine 212. CP-Network and CP-Device may be either the same or different interfaces in various embodiments.

While the present invention has been described as applied to mobile advertisements, the present invention in not limited to mobile advertisements. Other applications can take advantage of the event notifications described herein and are contemplated within the scope of the present invention.

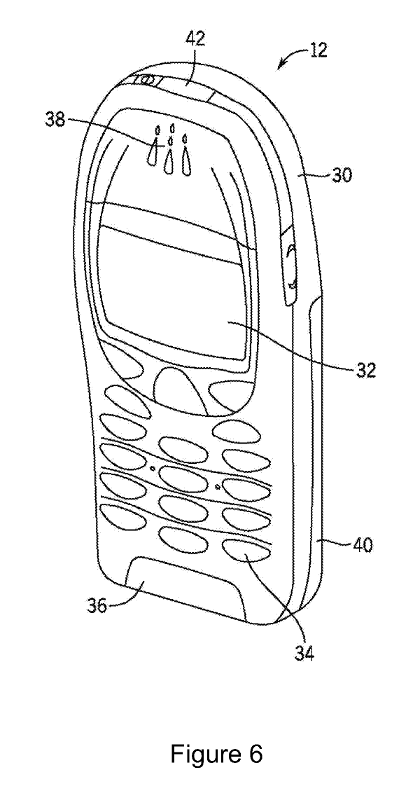

FIG. 6 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 6 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

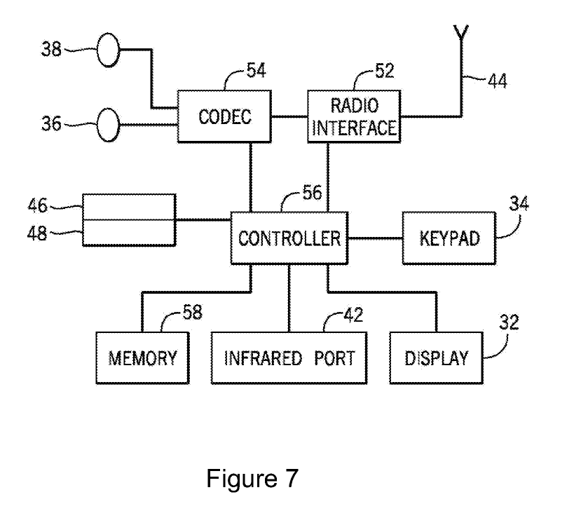

FIGS. 6 and 7 show one representative electronic device 12 which may be used as a network node in accordance to the various embodiments of the present invention. It should be understood, however, that the scope of the present invention is not intended to be limited to one particular type of device. The electronic device 28 of FIGS. 7 and 8 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 12 to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
determining a condition of a resource for a user device, the device having a software component thereon; and
sending a notification indicative of the condition of the resource to the software component.

2. The method of claim 1, further comprising:
sending a notification indicative of the condition of the resource to a server.

3. The method of claim 2, wherein the server is an advertisement server.

4. The method of claim 1, wherein the sending a notification includes sending the notification to the software component if the condition of the resource is determined to be critical.

5. The method of claim 1, wherein the notification includes the operating level of the resource.

6. The method of claim 5, wherein the operating level indicates whether the resource condition is critical or normal.

7. The method of claim 6, wherein the operating level further indicates a percentage availability of the resource.

8. The method of claim 1, wherein the software component is an advertisement application.

9. A method, comprising:
receiving a notification from an engine, the notification being indicative of a condition of a resource for a user device; and
implementing corrective action based on the condition of the resource.

10. An apparatus, comprising:
a processor
memory including computer program code the memory and the computer program code configured to, working with the processor, cause the apparatus to perform at least the following:
determine a condition of a resource for a user device, the device having a software component thereon; and
send a notification indicative of the condition of the resource to the software component.

11. The apparatus of claim 10, wherein the memory unit further includes:
computer code for sending a notification indicative of the condition of the resource to a server on a network.

12. The apparatus of claim 11, wherein the server is an advertisement server.

13. The apparatus of claim 10, wherein the computer code for sending a notification includes computer code for sending the notification to the software component if the condition of the resource is determined to be critical.

14. The apparatus of claim 10, wherein the notification includes the operating level of the resource.

15. The apparatus of claim 14, wherein the operating level indicates whether the resource condition is critical or normal.

16. The apparatus of claim 14, wherein the operating level indicates a percentage availability of the resource.

17. The apparatus of claim 10, wherein the software component is an advertisement application.

18. An apparatus, comprising:
a processor
memory including computer program code
the memory and the computer program code configured to, working with the processor, cause the apparatus to perform at least the following:
receive a notification from an engine, the notification being indicative of a condition of a resource for a user device; and
implement corrective action based on the condition of the resource.

19. The apparatus of claim 18, wherein the memory unit further includes:
computer code for sending a message to the engine indicating the corrective action implemented.

20. The apparatus of claim 18, wherein the notification indicates that the condition of the resource is critical.

21. The apparatus of claim 18, wherein the notification includes the operating level of the resource.

22. The apparatus of claim 21, wherein the operating level indicates whether the resource condition is critical or normal.

23. The apparatus of claim 21, wherein the operating level indicates a percentage availability of the resource.

24. The apparatus of claim 18, wherein the engine is an advertisement engine.
